(19) United States
(12) Patent Application Publication
(10) Pub. No.: US 2007/0222349 A1
(43) Pub. Date: Sep. 27, 2007

(54) Method and apparatus for cooling high power flash lamps

(76) Inventors: Robert M. Lantis, Ashburn, VA (US); Boris Zlotin, West Bloomfield, MI (US); Peter Ulan, Wolverine Lake, MI (US); Vladimir Proseanic, West Bloomfield, MI (US); Gafur Zainiev, West Bloomfield, MI (US)

Correspondence Address: MILES & STOCKBRIDGE PC, 1751 PINNACLE DRIVE, SUITE 500, MCLEAN, VA, 22102-3833, US

(21) Appl. No.: 11/634,946

(22) Filed: Dec. 7, 2006

Related U.S. Application Data
(60) Provisional application No. 60/742,883, filed on Dec. 7, 2005.

(51) Int. Cl. H01J 7/26

(52) U.S. Cl. 313/12

(57) ABSTRACT

Broadband output high power pulsed flash lamps are useful in many applications, including beacons, communications, imaging, laser pumping, and materials processing. When specifically optimized, they can become an excellent source of ultraviolet (UV) light, which is particularly useful for photo-chemically-induced materials processing applications. Ultraviolet lamps producing high power pulsed ultraviolet (PUV) light can be ideally suitable for use in the decontamination of fluids (particularly water, wastewater, and other liquids, gases and objects), and for other applications such as photo-enhancement of chemical reactions, treatment of light sensitive materials, medical use, and so forth. In many operation scenarios the required pulsed energy transfer (high average and/or peak power) and subsequent thermal effects may create certain detrimental effects, such as reduction of lamp efficiency, changes in lamp spectral output, reduction of the delivered radiation due to fouling of optically transmitting surfaces, damage of lamp components, and reduction of lamp service lifetime, thereby requiring the use of an ancillary lamp cooling system. As newly designed flash lamp systems may require performance and power levels that exceed those of the traditional order, the heretofore known cooling methods can be problematic and inadequate for meeting increased requirements of the newest generation of high power pulsed flash lamps. This invention creates several new and advantageous methods to provide the increased cooling performance capabilities dictated by such high power pulsed flash lamps.

### FIELD OF THE INVENTION

The present invention relates to the design and manufacture of cooling systems for lamps. Specifically, the present invention relates to the design and manufacture of cooling systems for lamps that produce high power (peak and average) pulsed broadband light, including those intended to produce pulsed ultraviolet (PUV) light, and continuous wave (CW) mercury lamps.

### BACKGROUND AND SUMMARY OF THE INVENTION

It is known that system designs for medium and high power flash lamps typically include a lamp envelope, electrodes, and a surrounding cooling jacket. The lamp envelope is generally made of tubular material with adequate transparency for the desired spectral emission band(s) (e.g., UV-grade quartz for UV radiation), and filled with gases such as xenon, krypton, or other suitable gas(es). Electrodes are located in opposite ends of the tube, connected to the source of high voltage and current and producing an electrical discharge in the gas.

FIG. 1 illustrates an example of a surrounding cooling jacket of suitably transparent material around the circumference of the lamp envelope, providing a volume for circulation of cooling fluid (gas or liquid, typically de-ionized water) between the lamp exterior surfaces and the internal surface of the jacket, providing removal of excess heat developed during the lamp operation.

While there are many known styles and methods for operating pulsed flash lamps, it is most common for medium and high power pulsed lamp operation to include some version of three typical operating modes: an ignition mode, a simmer mode, and a pulse mode. The ignition mode provides the initial electrical breakdown and ionization of gas inside the tube by a special high voltage igniter. The simmer (standby) mode is provided by a small current that provides between the high power pulses a constant low level of gas ionization inside the tube, thereby maintaining a lowered electrical impedance. The pulse mode is produced by short, high power and high voltage discharge inside the tube with duration between microseconds and milliseconds, and developing pulses with peak power from one to hundreds of megawatts.

The design, operation, and output characteristics of CW mercury lamps contrast significantly with those of high power PUV flash lamps, and since these CW mercury lamp characteristics are well known by practitioners of the art, an exhaustive comparison is not presented herein. Several important differences inherent with CW mercury lamps include: some amount of mercury and/or mercury amalgam is required inside the envelope in order to produce UV light; static fill pressures are several to over one thousand times higher than that of flash lamps; efficient UV output requires warm-up time and a particular optimum temperature; both the power input to the lamp and the light output are continuous (non-pulsed); variations in input power can produce less efficient UV generation; On-Off cycling is detrimental to lamp lifetime; the annular volume between the lamp and cooling jacket must be gaseous (non-liquid); and the cooling jacket temperature is dramatically higher than that of flash lamps.

All high power flash lamp modes produce heat, which should be controlled, in the working gas and surrounding materials, so the lamp cooling system must remove excessive (that is, performance-limiting) heat. Heretofore typical high power flash lamp systems rarely consume more than 5 or 6 kilowatts of energy, and therefore require a cooling system that is similar to that already described and exemplified in FIG. 1. Most of the heat excess is produced by simmer current and high energy pulses.

The growing demand by new applications for increased processing power has in many instances required much improved flash lamp performance. In order to extend both power and performance capabilities beyond the level of typical medium to high power flash lamps, new methods and equipment are required. For example, large-scale water disinfection and remediation is just one application whereby a new generation of higher power and performance PUV lamps is highly advantageous. In this setting, UV light can effectively disinfect across a broad range of targeted pathogens. In sharp contrast with chemical disinfectants such as chlorine, UV light can disinfect without adversely affecting the taste, odor, or safety of the water, and is particularly effective against Cryptosporidium Parvum protozoa. Additionally, pulsed UV systems deliver UV light with neither the hazardous mercury, nor the explosive potential created by high lamp envelope temperatures and pressures that are inherent in conventional continuous wave (CW) medium pressure UV lamps. Furthermore, it is known that the CW mercury lamps (among others) have an inherent problem of performance degradation due to thermal gradient induced fouling (minerals attraction) of lamp cooling jackets. Utilizing a unique lamp cooling system embodiment (herein), pulsed flash lamps can operate in a “non-fouling” mode.

In order to achieve these, and other advantages of the latest and highest power pulsed flash lamp systems, certain improvements beyond the prior art are required. The cooling methods for the older generation of lower power flash lamps are inadequate to the task; this invention provides necessary solutions.

As an example of one such new higher power and performance flash lamp optimized for PUV applications, the simmer current of a flash lamp with a diameter of 9 mm and arc length of one meter may require energy of up to 1 kilowatt, and each high energy discharge pulse might produce an additional 0.5 kilowatt of heat. Since the regime of UV lamp operation might include pulse repetition frequencies up to 50 Hz (or more), there could be a need to transfer about 20-30 kilowatts of heat in order to provide a stable UV lamp working environment.

This high power PUV lamp advantageously uses for removal of excess heat a liquid coolant (e.g., water), which is pumped at a high linear velocity through a narrow annular channel between the lamp envelope and cooling jacket (FIG. 2). The turbulence created by such an arrangement serves to disrupt and minimize the static boundary layer of coolant in contact with the lamp envelope exterior, thereby preventing an interruption in the rate of thermal exchange due to an undesirable phase change (liquid to gas). Nevertheless, certain characteristics of coolant circulation have the potential to become a source of several problems.

According to theoretical calculations of and empirical data from pulsed flash lamp operation, very high power pulses can produce high forces that create compression and tension stresses in lamp materials. In particular, the high power pulses produce gas heating and pressure increase, axial and radial forces, and shock waves through the gas and tube walls. As a result: 1/axial waves propagate through the gas and envelope, completely or partially reflecting from tube ends, and can produce a set of multiple reflected waves that interfere and create standing waves and stress points in the envelope walls; and 2/radial waves propagate through the gas, envelope walls, cooling fluid and cooling jacket, traversing through boundaries with different material properties, completely or partially reflecting back and create standing waves and various stress points in the envelope walls. Multiple pulse sequencing with frequencies ranging from single to thousands per second (depending on system design and operating conditions) may create a resonance effect in lamps with natural frequencies in the same range. Resonance oscillations in lamps may produce detrimental pulsing tension and compression stresses in lamp components.

Shock waves and oscillations can contribute to the generation of “micro water hammer” and/or multiple other harmful effects, such as cavitation bubbles, adsorption rebinder effect, increased chemical activity of cooling water utilized in the process of PUV-based disinfection, influence of gases dissolved in water, water degassing, coolant flow perturbation, and fouling of lamp cooling jacket.

Cavitation bubbles are illustrated in FIG. 3 and refer to multiple shock waves propagating through the quartz tube, together with resonant oscillations of the tube and the required high velocity of water flow, may create on the tube surface, in the water, and on the surface of the cooling jacket conditions promoting cavitation, which produce micro-zones of discontinuity within the coolant. The subsequent rapid collapse of micro-bubbles produces tiny, high-energy water jets. It is known that cavitation jet nibs include ionized atoms. Multiple cavitation bubbles create large number of ionized centers that may absorb UV radiation and result in reduction of lamp efficiency and additional energy supplied to cavitation bubbles and jet nib, which increases the harmful effects of cavitation. These tiny and very concentrated water jets can pierce the surface of an adjacent object and cause its erosion, which in this case: stimulates and promotes emerging of micro-cracks in the lamp tube surface; reduces the tube transparency for UV radiation (which diminishes the dose of UV radiation produced by lamp and increases heating of quartz tube); and contaminates the cooling water with products of cavitation erosion.

Micro-crack development in the outside layer of the tube can be strengthened by the influence of adsorption Rebinder effect: a liquid with a good wetting capability on the surface of certain materials is capable of creating a detrimental weakening effect on the strength and integrity of those same materials. This can occur when capillary forces promote penetration of liquid deep into the tip of even the smallest micro-cracks, thereby resulting in the creation of strong local cleaving pressures similar to the effect of the splitting forces of a wedge (FIG. 4). The adsorption Rebinder effect can be greatly intensified by the addition of other (externally generated) pressure waves propagating through the liquid and/or material (as is the case with high power flash lamps).

Water (including distilled and deionized water) has a cluster structure that in many regards defines the water chemical properties. In fact, water with a distorted molecular cluster structure often has unusual properties (still not completely known and understood) depending on the cause of distortion. Examples of means to distort the molecular structure include: very intense mechanical mixing (disintegration); active cavitation (e.g., due to powerful ultrasonic fields); boiling; phase-changed water; and influence of strong electrical pulses that initiate a rotation of polarized molecules of water, thereby destroying existing molecular connections. Once distorted, the water cluster structure restores quite slowly, taking from dozens of minutes to several hours. During the operation of high power flash lamp systems, the following effects have the capability of increasing the chemical activity of lamp cooling water: water photolysis with creation of active ions H+ and OH−; water ionization with creation of active ions H+ and OH due to water cavitation; and water polarization due to molecular rotation under the influence of strong electrical pulses. It is known from the literature that many chemical reactions work differently in strong electric and magnetic fields. In particular, non-reactive materials may react in the presence of strong electric fields. It is therefore possible that, during high energy electrical pulses utilized in certain flash lamp systems, some yet unknown reactions take place between the water and quartz or glass surfaces comprising the lamp and/or cooling jacket.

After some number of pulses it is reasonable to expect that the cooling water could change to a strongly distorted cluster structure that could lead to the following effects: dissolving and washing away of certain component materials from which the lamp envelope and/or cooling jacket are constructed, such as quartz (or glass) tubes, polymer fittings and piping and stainless steel parts; chemical dissolving (disintegration) of lamp and cooling jacket surfaces, thus reducing the optical transparency and system efficiency; and deposition of dissolved elements on the surfaces of the lamp and cooling jacket. This is particularly detrimental because if even a small amount of iron and chromium were slowly washed away and deposited on the lamp and cooling jacket, the desired lamp radiation output level could become substantially compromised.

Distilled water usually contains a small amount of gas, including oxygen, nitrogen and carbon dioxide. The amount of each gas could differ, but a practical approximation could be: oxygen about 10·10⁻⁶, nitrogen 20·10⁻⁶, carbon dioxide 5·10⁻⁶. The effects of this small amount of dissolved gas is usually not taken into consideration, because it cailnot normally produce a sizable chemical effect. However, this chemistry may behave differently in the presence of extremely high intensity UV radiation, strong electrical fields, and water cavitation. Dissolved gases could be ionized and interact with water and other materials, thereby creating contaminants and chemically active substances. Moreover, if the cooling water eventually is in contact with outside air, it can continually absorb more gases and further compromise the purity of the water.

Water degassing can also be detrimental to the integrity of such a lamp cooling system. It was formally believed “water and oil don't mix.” However, it is now known that the miscibility of water and usually highly dispersant substances (oil-like and others) is greatly improved when the water is first “degassed”. It has been shown that combinations of compounds previously believed to be non-miscible are indeed dispersible with water that is free of dissolved gases. Given this fact, one can suggest that within a high power flash lamp cooling process, the degassing effect can take place due to dissolved gas ionization and transformation into other (non-gaseous) substances, as presented above. The resulting distilled and degassed water can create an additional and much stronger chemical reaction with wetted materials (including quartz and glass). Together with other factors, water degassing could contribute to undesired changes in the surfaces required for transmission of lamp radiation, in addition to chemical reactions with other wetted components comprising the flash lamp coolant system.

Various thermodynamic effects during high power flash lamp operation can detrimentally result in a gradual bending or bowing of the lamp envelope, resulting in axial asymmetry between the positions of lamp tube and cooling jacket (FIG. 5). This asymmetry changes the size of the cooling channel and amount of water flow around the periphery of the lamp. The resulting non-uniform cooling further amplifies the harmful effects, thereby promoting ever-increasing deformation of the lamp envelope. In addition to the effect of these two detrimental factors, there are harmful effects of hydraulic shock and lamp oscillation according to fundamental and harmonic frequencies of the lamp tube. The combination and interaction of these effects, along with the restriction of the cooling water channel and resulting localized higher velocity water flow, can produce at times other detrimental conditions. Examples are: local oscillations of cooling water velocity/pressure; localized overheating and increase in material stress; development of micro-cracks; higher average lamp gas temperature/pressure; diminished lamp cooling efficiency; electrical and optical attenuation of desired radiation emission; and reduction of lamp service lifetime.

When utilized in water and wastewater remediation applications, continuous wave (CW) mercury lamps have an inherent problem of performance degradation due to thermal gradient induced fouling (minerals attraction) of lamp cooling jackets (FIG. 6). Because these conventional CW mercury lamps are primarily cooled through the outer walls of the cooling jacket that is in contact with the process water being treated in the UV reactor, there is an inherently large differential temperature between the solid (quartz) and the water. This process water usually contains dissolved and/or suspended mineral compounds based upon iron, manganese, and calcium, among others. It is known that an increase in the rate of mineral deposition upon the jacket (fouling rate) is a function of increasing temperature differential between the jacket and the minerals-laden process water. Both iron and manganese are highly UV absorbent, so a fouled cooling jacket can be detrimental to both the efficacy and efficiency of UV-based disinfection systems. As evidenced in FIG. 6, the much higher operating temperatures of Medium Pressure mercury lamps (>600 C) and associated jacket-to-water temperature differential leads to a faster rate of fouling than experienced with the lower operating temperatures (<100 C) of Low Pressure mercury lamps. However, the overall performance of Low Pressure mercury lamp installations, which do not foul as quickly as medium pressure mercury lamps, have always been seriously compromised by themially-induced minerals fouling. These lamps always require some method of active maintenance (e.g., acid wash and/or mechanical wiping) in order to be useful, and the user always bears the increase expenses resulting from lower efficiency, materials and labor costs, system downtime, and reduced safety.

Attempts to minimize the detrimental performance effects of fouling have consisted of incorporating some form of mechanical wiping system and/or acid etch system in order to remove the compounds that have already deposited upon the cooling jacket. Importantly, such methods neither prevent the occurrence nor lessen the rate of fouling; instead, they try to remove the deposits after they have already adversely affected the performance, thereby restoring some of the previously lost light transmission. Prior to this invention, there has been no effective method that advantageously impedes or prevents the deposition process that is responsible for jacket fouling and its subsequent performance degradation. The methods of prior art instead accept the undesirable fouling, and loss of light and process efficiency, and then later attempt to reduce the magnitude of its effects by means of a cyclical mechanical/chemical remediation operation.

An inherent characteristic of continuous wave (CW) mercury lamps is that they require a particular (and ideally, a non-varying) operating temperature for delivery of their most efficient and consistent light output. In order to come close to this requirement, CW lamps are limited to using gas convection cooling in direct contact with the lamp, and then transferring the heat load of the gas by means of conduction through the cooling jacket and into the surrounding process water. The reduced coefficient of thermal transfer provided by the gas convection cooling stage allows the CW mercury lamp to achieve the higher temperature condition required for UV production. Therefore, conventional CW lamp systems have a cooling jacket that is necessarily at a high temperature relative to the process water.

Unpublished data from older design high power flash lamp systems (i.e., those operating without the benefit of this invention) indicate that such systems characteristically exhibit a dramatically reduced level of mineral fouling. This is because these pulsed lamps, in contrast to CW mercury lamps, are advantageously directly cooled by fluid located between the lamp and the cooling jacket. This arrangement allows the outer wall of the cooling jacket to enjoy a much lower temperature relative to that of CW mercury lamps, and a subsequently lower differential temperature gradient; thus, their reduced rate of fouling. While this is indeed a major improvement, there exists, none-the-less, a strong need for eliminating entirely the problem of lamp fouling. Utilizing a unique lamp cooling system embodiment (as set forth herein), pulsed flash lamps are able to advantageously operate in a “non-fouling” mode.

Accordingly, a primary object of the present invention is to eliminate and reduce disadvantages of prior art mentioned above. In response to the water industry's compelling need for achieving the highest levels of safety, accuracy, and efficiency that performance-based PUV disinfection systems can deliver, the present disclosure provides many examples related to flash lamps that are optimized for UV processing applications, and in particular, for water disinfection. However, it is understood by practitioners of the art that this invention and its various embodiments can be advantageously utilized across the broad range of high power flash lamp applications, and its implementation is not limited to any particular light output spectrum, process, or industry.

A further object of this invention is to provide a reliable and cost-effective UV lamp cooling system that also serves to help prevent lamp breakage by pulses of radiation.

A further object of this invention is to provide a reliable and cost-effective lamp cooling system that promotes UV lamp efficiency and minimal UV radiation and energy losses.

A further object of this invention is to provide a reliable and cost-effective lamp cooling system that mitigates the problem of lamp fouling.

A further object of the present invention is to provide lamp designs that mediate better lamp cooling in order to mitigate the potential for lamp degradation and breakage, maintain a stable set of optimum operating conditions, and maximize the lamp efficiency for the desired spectral emission band.

A further object of the present invention is to provide lamp cooling system designs that simultaneously solve other non-cooling-related problems, such as shockwave, pressure, and resonant vibration—induced fatigue and failure of lamp materials.

A further object of the present invention is to provide lamp cooling system designs that advantageously mitigate the detrimental mineral fouling of lamp cooling jackets.

A further object of this invention is to provide a reliable and cost-effective UW lamp cooling system that also serves to help prevent lamp breakage by pulses of radiation.

A further object of this invention is to provide a reliable and cost-effective lamp cooling system that promotes UV lamp efficiency and minimal UV radiation and energy losses.

A further object of this invention is to provide a reliable and cost-effective lamp cooling system that mitigates the problem of lamp fouling.

A further object of this invention is to provide designs that are also beneficial when used in conjunction with CW mercury lamps.

These and other objects are achieved in the present invention.

There has thus been outlined, rather broadly, the more important features of the invention in order that the detailed description thereof that follows may be better understood, and in order that the present contribution to the art may be better appreciated. There are, of course, additional features of the invention that will be described further hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that equivalent constructions insofar as they do not depart from the spirit and scope of the present invention, are included in the present invention.

For a better understanding of the invention, its operating advantages and the specific objects attained by its uses, reference should be had to the accompanying drawings and descriptive matter which illustrate preferred embodiments of the invention.

### BRIEF DESCRIPTION OF THE DRAWINGS

FIG. 1 illustrates a typical medium to high power flash lamp cooling system.

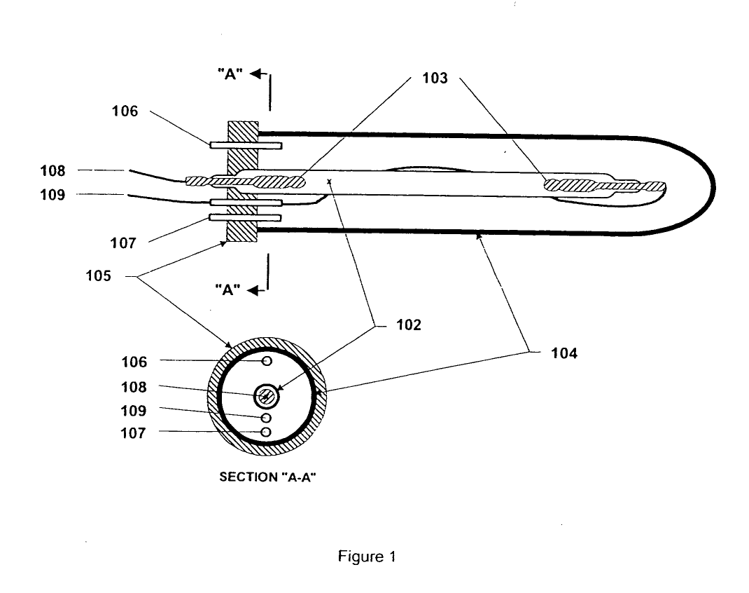

FIG. 2 illustrates certain components of a very high power flash lamp cooling system.

FIG. 3 illustrates a sequence of conditions comprising the formation of liquid cavitation.

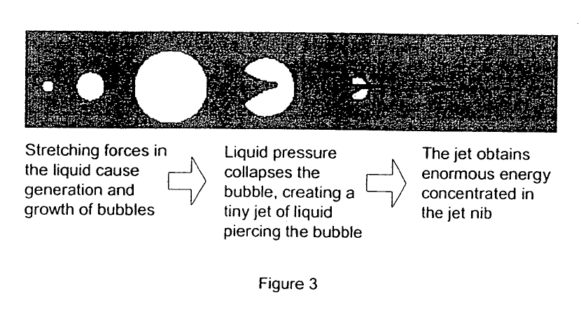

FIG. 4 illustrates the condition and results of adsorption Rebinder effect.

FIG. 5 illustrates some differences between operating with a straight lamp and a bowed lamp.

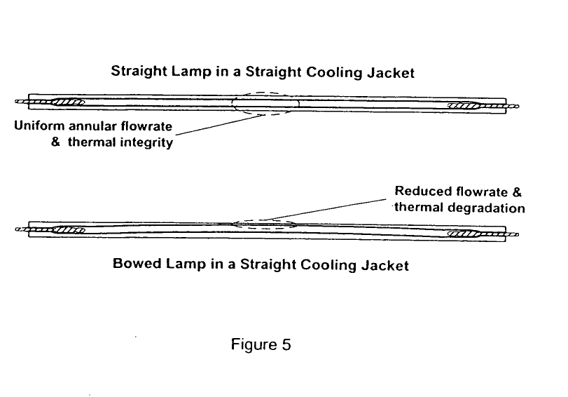

FIG. 6 illustrates an example comparison of mineral fouling rates under various conditions for Medium Pressure and Low Pressure Continuous Wave (CW) mercury lamps.

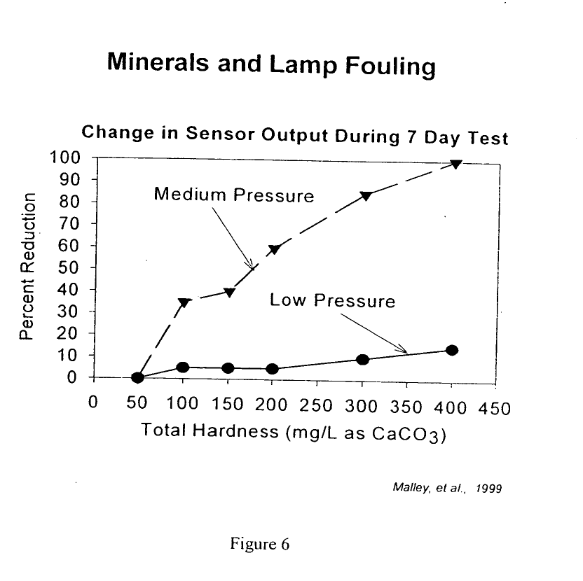

FIG. 7 illustrates a forced gas cooling system utilizing flexible panels or tubes.

FIG. 8 illustrates a forced gas cooling system that creates a liquid and gas mixture within the reactor process medium.

FIG. 9 illustrates a gas-lift system for lamp cooling.

FIG. 10 illustrates the deleterious results of liquid cavitation upon lamp and cooling jacket surfaces.

FIG. 11 illustrates a transpiration cooling system.

FIG. 12 A-C illustrates several methods of mechanical and thermal attachment between a lamp and cooling jacket.

FIG. 13 A illustrates another example of a multiple longitudinally-ribbed lamp envelope, FIG. 13 B illustrates an example of wave-shaped cooling jacket. FIG. 13 C illustrates a cooling jacket with integral internal radial ribs, FIG. 13 D illustrates examples of cooling jackets with special cross-section shapes.

FIG. 14 A-B illustrates the temperature relationship-induced compound attraction process at the interface of a cooling jacket and surrounding process liquids.

FIG. 15 illustrates an example of an invention that provides stable control of operating temperature and greatly reduces thermally-induced fouling for Continuous Wave (CW) mercury lamps.

### DETAILED DESCRIPTION OF THE PREFERRED EMBODIMENTS

In order to satisfy the above mentioned objectives, the present invention addresses issues including but not limited to: selection of various suitable media for the lamp cooling system; changes in coolant operating parameters; introduction of special additives for modification of the coolant properties; various methods of coolant treatments for prevention of negative transformations of coolant properties before, during, and after operation; preventing the degradation of coolant properties by means of special treatment of the lamp components; various modifications of the lamp and cooling system design can be focused upon improvement of cooling efficiency; mitigating the problem of fouling of the lamp cooling jacket; and selection of various suitable media for the lamp cooling system.

It is known that in some cases there are detrimental effects related to PUV lamp performance and lifetime that are caused by interactions between lamp components and lamp coolant in the presence of high peak power pulses of electrical current, UV radiation, and the effects of shock wave propagation through the lamp gas, quartz and/or glass components, and the lamp cooling fluid.

An ideal lamp coolant agent would exhibit the following properties: chemically inert to the materials of lamp tube and envelope; very transparent to the UV radiation; does not change properties in the presence high level UV radiation; has good thermal exchange characteristics; and produce neither cavitation nor Rebinder effects. In a preferred embodiment of the present invention such lamp coolant agent is a high stability liquids such as the various families of fluoro-, perfluoro-, hexafluoro-, hydrofluoro-, organosilicons, etc. In a further embodiment, such cooling agent comprises one or more hydrophobic additives. In a further embodiment, such cooling agent is free from atmospheric gases including but not limited to oxygen, nitrogen, and/or carbonic gases. In a further embodiment, such cooling agent is degassed before, during, or after installation into the cooling system. In a further embodiment, such cooling agent is degassed during lamp utilization. In a further embodiment, such cooling agent is pressurized in the range of 15 psi to 150 psi.

An alternative is to utilize a forced gas cooling system instead of a liquid-based system. Most gases are transparent to flash lamp radiation. Many industries have extensive experience with designing, building, and maintaining gas cooling systems for various applications and throughout a broad range of heat transfer capacities; none-the-less, prior to this invention there has been neither the perceived need for nor the methods by which adaptations of this air cooling technology could be advantageously implemented for high power flash lamp systems.

A further alternative is a combination liquid/gas coolant system.

The most known and deployed gas cooling systems utilize air as a cooling medium. However, in certain high power flash lamp applications the potential for ozone generation is viewed as problematic. There are, none-the-less, certain applications and embodiments where this ozone could be advantageously utilized as part of the process, thereby increasing the process efficacy. One such example would be to direct the used (and heated) coolant air through the process water flowing through the reactor. In addition to the creation of a passively-cooled, highly efficient, and direct air-to-liquid heat exchanger, the infusion of photolytically-induced ozonized air could produce secondary effects of powerful chemical dissociation within the process water, and augment the direct photo dissociation effects of the flash lamp. In a preferred embodiment, such cooling agent is a gas passive to UV radiation, in that it does not absorb UV radiation and it is not detrimentally changed by UV radiation. Preferably, such cooling agent is argon, hydrogen, helium, or Freon.

For applications that would not improve by means of indirect (chemical) dissociation techniques, other gases such as helium and argon could also be good choices for their chemical inertness and stability in many aggressive types of environment. Substances such as Freon and hydrogen are known for their excellent heat transfer properties.

A forced gas cooling system for high power PUV flash lamps can eliminate many of the known problems sometimes encountered in their respective lamp cooling system (water-quartz interaction, high thermal-gradients, and mechanical stresses in the tube walls, etc.,). The average temperature of an air-cooled reactor could become higher, but also more uniform and subsequently less stressful to lamp components.

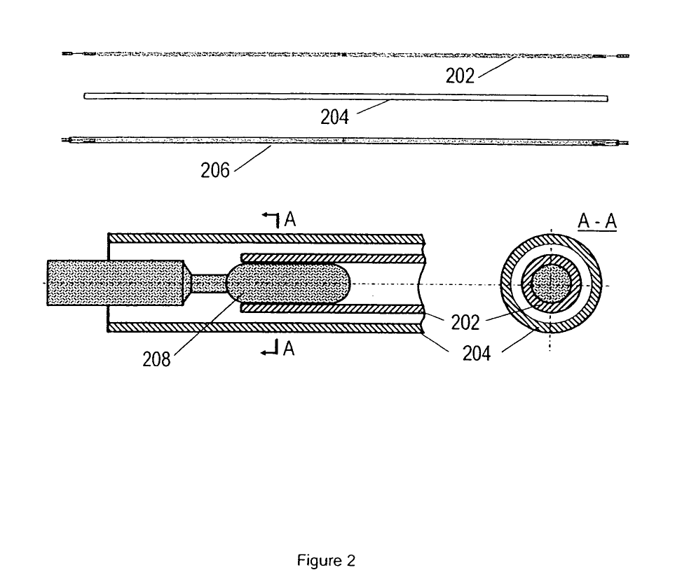

FIG. 2 illustrates portions of a single high power pulsed ultraviolet (PUV) flash lamp assembly comprising lamp 202, cooling jacket 204, and lamp/jacket assembly 206. The flash lamp comprises a central tube of material transparent to UV radiation. In a preferred embodiment such tube comprises quartz. The tube volume is filled a the working gas under a partial vacuum. Electrode(s) 208 are hermetically attached near the ends of the lamp tube (or envelope), connected to a high voltage pulsed power source that produces an electrical discharge in the working gas. Such electrodes supply current to the gas inside the tube. A larger tube of UV transparent material, commonly called cooling jacket 204, is located around lamp 202, creating an annular channel between lamp 202 and cooling jacket 204 walls. Lamp cooling agent flows through this channel, thereby removing most of the excess heat produced during lamp operation. In a preferred embodiment, cooling agent is evacuated by means of a sub-atmospheric pressure, preferably at a pressure less than 70,000 pascal.

High peak power pulses during lamp operation are responsible for transient lamp gas pressure increase and heating, development of axial and radial forces in tube material, and shock waves through the gas and tube walls. As a result, the accumulation of high peak stresses in the envelope material (quartz or glass) could lead to a degradation of envelope shape, strength, the development of micro-cracks, and premature failure.

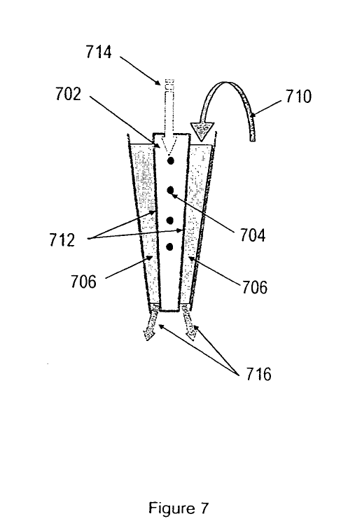

FIG. 7 illustrates a forced gas cooling reactor that has central vertical gas channel 702. One or more UV lamp(s) 704 are located within gas channel 702. Preferably a plurality of UV lamps 704 are located in parallel to each other. Preferably UV lamp(s) 704 do not have coaxial jackets. This “non-coaxial jacket” design provides efficient interaction between lamp tubes and gas coolant, good heat transfer and evacuation, and minimal yet manageable changes in the delivery of UV dose.

Wedge (or in an alternate embodiment, uniform) shaped channel(s) 706 are located around the sides of gas channel 702. Such shaped channel(s) 706 can contain contaminated water 710. Interior walls 712 comprise UV transparent panel(s). In one embodiment, interior walls 712 are comprised of sheets of flexible polymer material, such as FEP or Aclar™. Forced coolant gas 714 is provided to upper portion of gas channel 702. By matching the pressures of coolant gas 714 and contaminated water 710, the differential pressure is maintained sufficiently low in order to allow a suitably thin membrane to safely provide a beneficial combination of fluid(s) separation, thermal compatibility, non-fouling surfaces, non-shattering surfaces (as opposed to quartz), and a relatively inexpensive construction (given the large surface areas). Disinfected water 716 emerges from lower portion of shaped channel(s) 706.

In an alternate embodiment, such a vertical reactor configuration can allow the use of gravity flow and subsequently lowered energy requirements for water pumping. Additionally, the vertical walls of the process water channel have neither horizontal surfaces nor inclusions/extrusions that encourage deposition of particles from the process water or fluid. In this embodiment, it is evident that the benefits of the design of such a cooling “jacket” extend beyond just the cooling system, and into the actual reactor design, thereby enabling new capabilities for high power flash lamp processing.

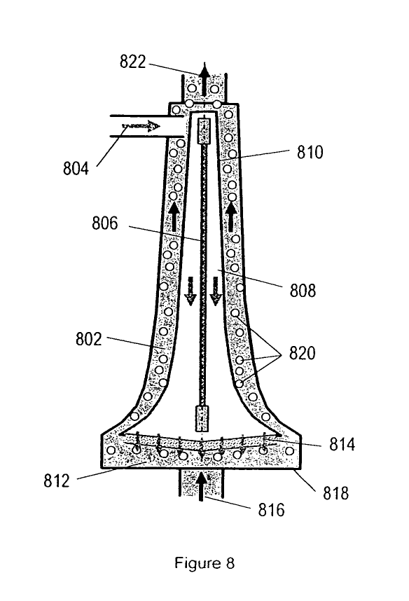

FIG. 8 illustrates deployment of liquid and gas mixtures 802 as an alternative method to remove large amounts of heat from the flash lamp assembly. Additionally, one of the known methods to reduce and/or eliminate cavitation is to use a water-gas (air) mixture with a large amount of gas bubbles entrained therein. The compression characteristics of bubbles make most liquids behave more elastically in response to fast transient pressure perturbations, and can dramatically reduce shock waves and their associated effect of surface erosion. Because most gases are transparent to UV radiation, multiple bubbles would not reduce the propagation of UV radiation through such a cooling mixture. Forced gas and/or air flow 804 is introduced as a cooling agent for the lamp 806 into the surrounding cooling region 808 and is generally confined by a UV transparent cooling jacket 810. Air flow 804 is maintained at a pressure higher than process water 812 and exits cooling region 808 through a porous media or nozzles 814 located near the process water upstream entry port 816. The gas and/or air flow 804, upon exiting the porous media 814, becomes entrained as gas bubbles 820 within the process water 812, thereby producing a liquid and gas mixture 802 that transits through the reactor vessel 818 while receiving exposure to the light from lamp 806. The lamp exposed liquid and gas mixture 802 leaves the reactor from the downstream exit port 822. This embodiment provides a direct-to-process water method of cooling the lamp, eliminating the requirement for a closed loop cooling system. An additional advantageous characteristic of such a lamp cooling system is that it simultaneously provides the opportunity for utilizing a nearly free air source as an oxygen-based photolytic-enhanced photodissociation process, thereby increasing the overall conversion efficiency in many applications.

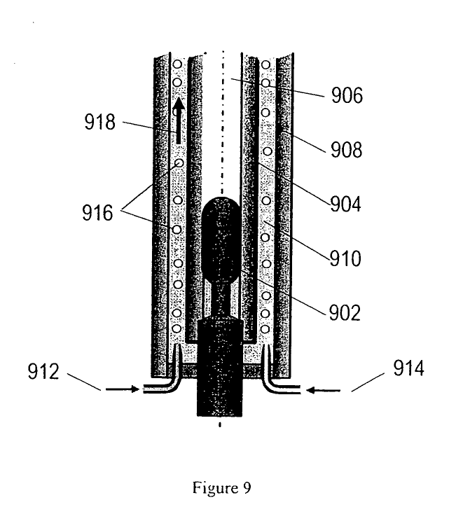

A large amount of gas bubbles in the cooling water can create an airlift effect, and in certain applications, reduce the requirements when electrically pumping the coolant through a vertically oriented UV reactor (FIG. 9). The primary lamp components requiring cooling, electrodes 902, lamp envelope 904, and gas 906, comprise a vertically-oriented lamp (partially shown) situated within a surrounding light-transparent cooling jacket 908 (partially shown). Suitable coolant liquid 910 enters the lamp cooling assembly through cooling liquid port 912 located at the bottom. Pressurized gas and/or air enters the lamp cooling assembly through airlift port 914 located at the bottom. One or more small nozzles or porous media (not shown) may be utilized to assist in the entrainment of gas within the coolant liquid 910, thereby forming gas bubbles 916, which rise to the top of the column and simultaneously transport the gas and cooling liquid mixture 918 upward towards the top of the column.

There are alternative means to improve the cooling effect of a water-air mixture, such as the utilization of air or water pulses for creating more turbulent cooling water flow, or the use of ice or CO2 added to the cooling water in order to keep the temperature constant and low.

Changes in coolant operating parameters are an excellent resource for necessary improvements to lamp cooling systems utilized in the new generation of high power flash lamps. Sequential high peak power pulses of electrical discharge and UV radiation generate shock waves and impart transient stresses in the lamp tube material. This leads to the potential for these stresses to eventually lead to the emergence and propagation of micro-cracks within the quartz or glass structure of the lamp envelope. Elimination of these adverse conditions could be crucial for enabling certain high power applications. The stress differential could be reduced to safe, negligible levels by the application of inward radial and axial compression forces that support and strengthen the walls of the lamp envelope. The coolant fluid flowing around the lamp could be a good resource for providing a uniform and consistent inward pressure, and thereby become instrumental in preventing sudden lamp breakage and enabling adequate lamp lifetime.

Higher coolant pressure could increase the cavitation threshold, thereby substantially reducing or eliminating its damaging effect on lamp envelope surfaces, such as the emergence and development of micro-cracks. In current designs for high power flash lamp cooling systems, this modification can be a very attractive and cost effective solution.

Modification of the coolant thermal characteristics is a basis for improvement of cooling system efficiency. In contact with the hot surface of the lamp envelope, cooling liquid between the lamp and cooling jacket has the potential to boil and evaporate (i.e., a liquid-to-gas phase change). Given the combinations of high peak thermal transients inherent with pulsed high energy operation; high thermal conductivity of a quartz lamp envelope; low average temperature of cooling fluid flow channel; and relatively static boundary layer of coolant molecules at the lamp outer surface, it is possible for a very thin layer of the liquid coolant in contact with the lamp to become vaporized. This phenomenon can simultaneously create two conditions the latent heat of vaporization during this phase change (only) actually increases the instantaneous thermal exchange efficiency of the coolant and/or the presence of any of the resulting gaseous coolant remaining in contact with the lamp surface will suddenly create at that surface a relatively poor thermal exchange between the lamp and the coolant, thus reducing the instantaneous thermal exchange efficiency of the coolant. Therefore, it is important to choose and carefully control the method by which the coolant interacts with the lamp surface. There are various combinations of embodiments of this method, each with their respective performance improvement characteristics that a skilled practitioner will understand as useful when well-matched to a particular high power flash lamp application to actively suppress a coolant phase change and/or actively produce a coolant phase change while simultaneously ensuring removal of vaporized fluid from the lamp surface.

In order to actively suppress a coolant phase change one can provide high turbulence flow along the lamp exterior surface; provide high pressure coolant in order to raise a coolant's effective vapor pressure temperature; provide a coolant with a higher vapor pressure temperature; and/or provide a coolant with lower average temperature. In alternate embodiments, one can use the following means to provide high turbulence flow along the lamp exterior surface: increase the linear velocity of the coolant; and/or add vortices-inducing components within the coolant channel. Means of adding vortices-inducing components within the coolant channel can include: modify the shape of the lamp exterior surface; add flow-shaping inserts between the lamp and jacket; modify the shape of the jacket interior surface; and entrain radiation-transparent and higher-density particles within the coolant.

One can actively produce a coolant phase change by providing lower pressure coolant in order to lower a coolant's effective vapor pressure temperature; providing a coolant with a lower vapor pressure temperature; and/or providing a coolant with higher average temperature. One can ensure removal of vaporized fluid from the lamp surface by providing high turbulence flow along the lamp exterior surface by either increasing the linear velocity of the coolant and/or by adding vortices-inducing components within the coolant channel. One can use the following means to add vortices-inducing components within the coolant channel: modify the shape of the lamp exterior surface; add flow-shaping inserts between the lamp and jacket; modify the shape of the jacket interior surface; and/or entrain radiation-transparent and higher-density particles within the coolant.

Controlled by variations in cooling agent composition, pressure, flow rate, turbulence, and boiling point, this method can substantially reduce or eliminate the problems increase the heat transfer ability, efficiency, integrity, and performance of high power flash lamp cooling systems.

This method can substantially reduce or eliminate the unique problems encountered in the process of cooling the new generation of high power flash lamp systems. By identifying and controlling certain variables in cooling agent composition, pressure, flow rate, turbulence, and boiling point, this invention provides an increase in the heat transfer ability, efficiency, integrity, and performance of high power flash lamp cooling systems.

It was mentioned above the importance of maintaining the stability of coolant properties when high energy electrical and UV radiation pulses produce various and often detrimental changes in lamp materials.

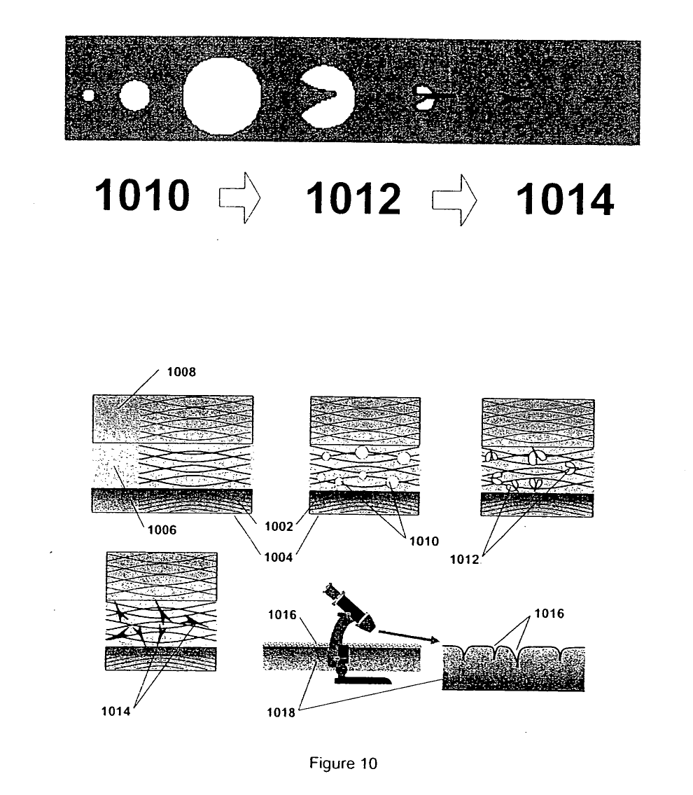

As illustrated by FIG. 10, multiple shock waves 1002 propagating through the lamp quartz envelope 1004, together with resonant oscillations of the tube and the required high velocity of cooling water flow, may create on the lamp envelope outer surface, in the cooling water 1006, and on the inside surface of the cooling jacket 1008 conditions promoting cavitation, which produce micro-zones 1010 of discontinuity within the coolant. The subsequent rapid collapse of micro-bubbles 1012 produces tiny, high-energy water jets 1014, which can chip out micro-particles of lamp components material, degrade the efficiency of UV transmission, and promote the emergence and development of micro-cracks 1016 in the lamp components 1018.

One solution to this cavitation problem is to provide better control of coolant conditions during operation of the high power flash lamp system, such as: a reduction of coolant flow velocity; the elimination or reduction of resonant oscillation of lamp components by means of better control of the magnitude, frequency, timing pattern, and firing order, etc., of the high energy electrical pulses delivered to the flash lamp; various methods of suppression, absorption, and redirection of shock waves and vibrations; a stronger, more stable 3-dimensional design of the lamp assembly, by means of the utilization of various types of lamp envelope-to-jacket connections (welds, connectors, ribs, etc.,) and local material redistribution (sleeves, supporting bushings, walls thickness variations, changes of tube and envelopes cross-sections, etc.,) and changing the coolant density by means of entraining multiple gas bubbles into the coolant flow, thereby increasing shock wave absorption and suppressing the formation of cavitation in coolant liquids.

It is known that the combination of high electric fields and high intensity UV pulses can produce in the water various effects that may result in water vibration and mixing, possible cavitation, ionization of water molecules, distortion of the molecular structure, photolysis, polarization, degassing, etc., Such changes in water properties can lead to activation of water chemical interactions with surrounding materials, activation of surfaces of all lamp components, and an increase in the “wetting ability” of the water.

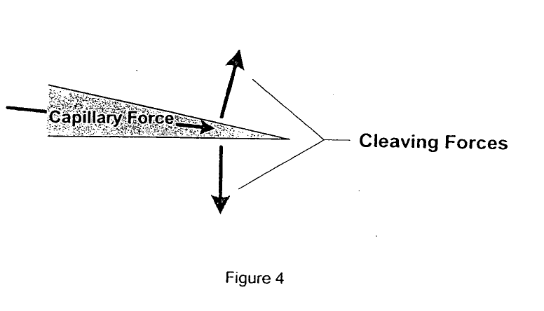

The combination of an increased water “wetting ability” along with its associated increase in capillary force can create conditions ideal for the appearance of Rebinder's effect, which is known to cause in many applications the premature degradation of strength and the subsequent failure of materials. Under conditions of increased wetting and vibration, the water capillary forces promote deep water penetration into the tips of even the smallest micro-cracks, thereby resulting in the creation of strong local cleaving pressures similar to the effect of the splitting forces of a wedge (FIG. 4). Rebinder's effect is known to many industries, and can usually be counteracted with the introduction to the coolant of some selected additives with hydrophobic properties that reduce the water “wetting ability”. Creating a lamp coolant that performs, in combination with the specific materials in contact with the coolant, as a non- or low-wetting liquid could be instrumental in substantially increasing the lifetime of high power flash lamp systems.

It is known that the effects of high power pulse radiation can change the properties of both water and water-based cooling agents. Various methods of coolant treatment can prevent detrimental transformations of coolant properties before, during, and after operation of high power flash lamps. Monitoring and correcting lamp coolant during the various stages of flash lamp operation can help to maintain a desirable set of coolant characteristics. The effects of aging, ionization, and contamination of coolant by micro-particles of lamp components etched away by activated water should be reduced to a minimal level. Introduced herein are several advantageous methods by which these detrimental effects can be mitigated: the rate of the coolant aging process could be reduced by degassing and keeping the liquid cooling agent free from atmospheric gases including oxygen, nitrogen and carbonic gases; the introduction of ion-exchange filtration into the cooling system loop; evacuation of gases within the coolant and cooling system piping; and continuous degassing during utilization of the lamp, thereby removing gaseous species generated during operation of the high power flash lamp.

The degradation of coolant properties can be mitigated by means of special treatment of the lamp components in order to hinder possible materials/coolant interactions. Certain changes in lamp design can be utilized in order to improve monitoring and conditioning of coolant properties. Lamp assembly component materials should be tested and chosen for their inertness to UV radiation and resistance to interaction with coolant that could become activated by UV pulses. Lamp and cooling system parts can be isolated from the coolant by non-metal materials, such as polyethylene or Teflon, or coated by a layer of hydrophobic material.

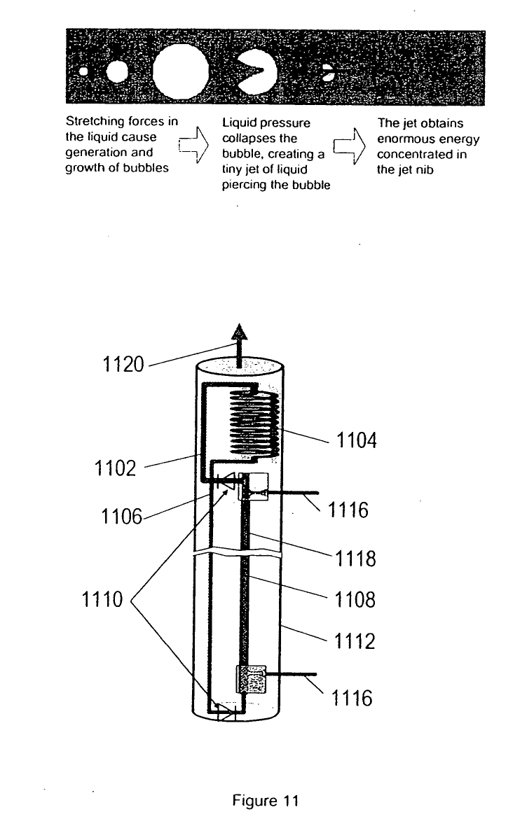

Various modifications of the lamp and cooling system design can be focused on improvement of cooling efficiency. For example, as illustrated in FIG. 11 a transpiration cooling system for the high power flash lamp can have a close-loop design, where evaporated medium 1102 is transferred to the system condenser 1104, and after that the liquid coolant 1106 is moved to the hot area between the lamp 1108 and cooling jacket 1118 in order to start another heat transferring cycle. The correct directional flow of the coolant entering and exiting the hot area of the lamp 1108 is maintained by appropriately positioned and oriented check valves 1110.

A vertically-oriented transpiration cooling system can produce efficient heat transfer. By placing the evaporator 1102 and condenser 1104 over the top of the lamp 1108, it is possible to create a pump-less circulation of cooling liquid that is entirely within the reactor 1112, thereby leaving only the electrical leads 1116 to the lamp as the only required ports though the sidewalls of the reactor 1112. The cooling system transfers the heat into the process water 1120 flowing through the reactor. Within this special case of high power flash lamp operation, some of the usual considerations regarding possible unwanted transition to so-called film evaporation are of little merit. High-intensity shock waves generated during lamp pulses operation can be sufficient to disrupt and destroy any gaseous film and/or displace any bubble formation near the tube wall.

Transpiration cooling can operate on distilled water or other UV transparent liquids such as alcohol or azeotropic mixtures. It is possible to modulate the cooling system pressure, which would make evaporation and system cooling parameters more controllable.

Various changes to lamp assembly cross-sections can be utilized for improvement of lamp cooling characteristics, and advantageously improving lamp durability and lifetime.

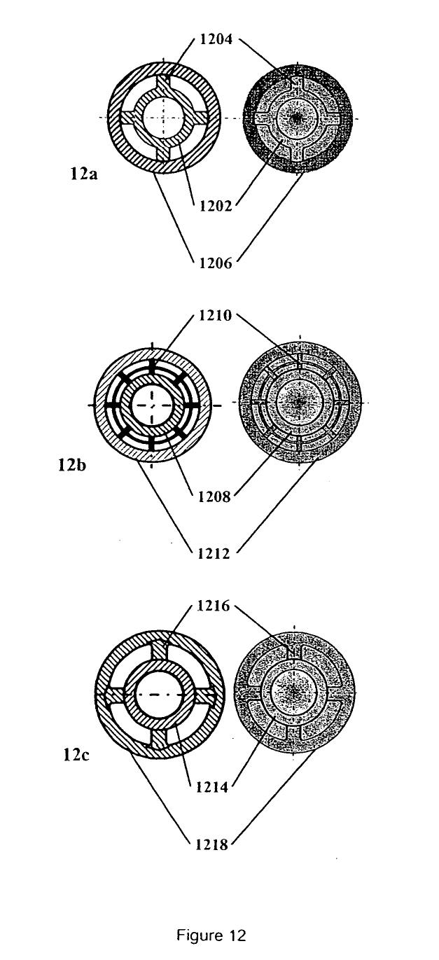

For example, as illustrated in FIG. 12A, lamp envelope 1202 with integral ribs 1204 improve the lamp rigidity and bending characteristics, thereby maintaining a straight lamp central axis for uniform annular cooling flow along the lamp 1206.

FIG. 12B illustrates one or more sets of ring like or annular ribbed spacers 1210 connecting lamp envelope 1208 with the cooling jacket 1212, thereby increasing the strength and dimensional integrity of the lamp assembly. In one embodiment, such spacers are designed and located such that thermal expansion resulting from lamp heating provides direct solid surface contacts between the lamp tube and cooling jacket, thereby promoting conductive heat transfer.

FIG. 12C illustrates cooling jacket 1218 with full or partial longitudinal ribs 1216 supporting lamp envelope 1214. In an alternative embodiment such ribs are ring like, annular or spiral. Partial ribs can be located in the zones of possible detrimental material stresses. In one embodiment, longitudinal ribs are located to suppress vibration modes. In another embodiment, longitudinal ribs are located to increase turbulence and thereby enhance efficiency of cooling agent.

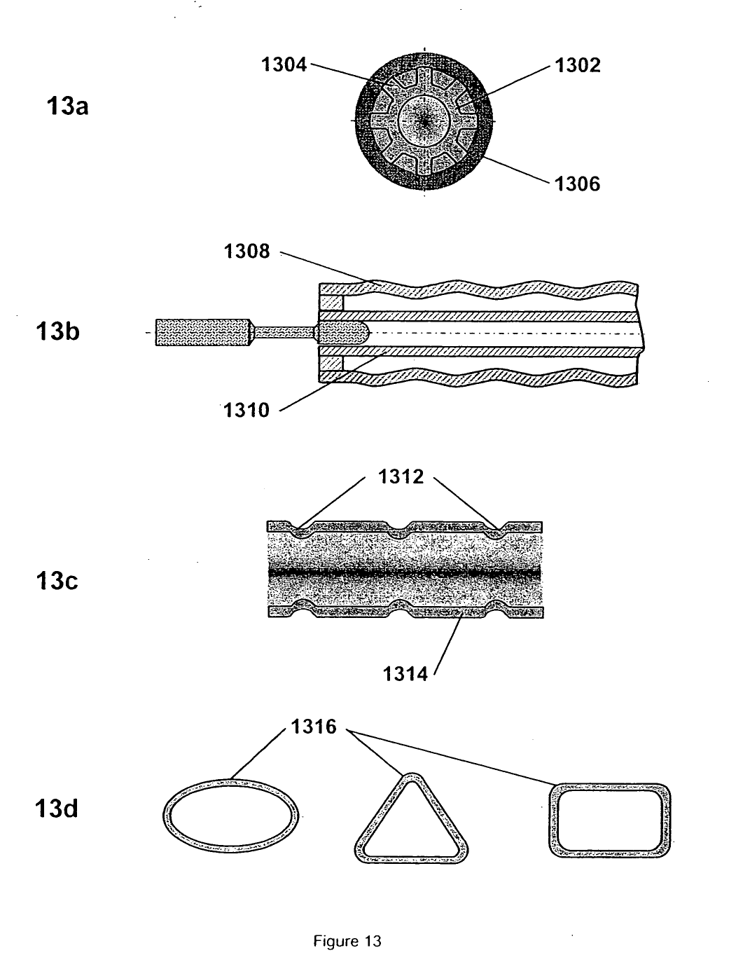

Additional examples of changes to lamp assembly cross-sections that can be utilized for improvement of lamp cooling characteristics, and advantageously improving lamp durability and lifetime are set forth in FIG. 13 A-D. For example, as illustrated in FIG. 13A, intermediate ribs 1304 located either on the lamp envelope 1302, cooling jacket 1306, and/or one or more annular insert(s) can perform an additional function of direct heat transfer from the lamp envelope 1302 to the cooling jacket 1306. Alternatively, some variants of lamp envelope and cooling jacket with spiral ribs and/or spiral outer rings can provide spiral water flow along the tube.

As illustrated in FIG. 13B, cooling jacket 1308 with waved shaped walls that increase cooling turbulence and that are able to disperse/attenuate shock waves originating from lamp 1310.

As illustrated in FIG. 13C, longitudinal and radial ribs 1312 made by plastic deformation of cooling jacket 1314 walls can provide additional effects of better jacket strength, increased cooling fluid turbulence, and shock wave attenuation.

As illustrated in FIG. 13D, non-round (such as elliptical or oval cross-section) cooling jacket 1316 can provide, in addition to increased mechanical strength, some additional non-uniform volume and structure surrounding the lamp periphery, thereby helping to attenuate the harmful effects of shock waves.

Thus, various changes to lamp assembly cross-sections can be beneficially utilized including but not limited to ribs located on outer and/or inner surfaces, tubes having depressions located on their outer and/or inner surfaces, and non-round tubes. Reinforcing ribs and/or depressions can be formed radially in the shape of annular ring or spiral elements, or in longitudinal form along the tube centerline. Similarly, longitudinal and radial ribs made by deformation of quartz or glass tube walls can provide an additional improvement in envelope physical strength and a reduction of problems related to bending, stress concentration, shock waves, etc. Such ribs can be on outer or inner surfaces. Further, such ribs and/or depressions can be discontinuous. In an alternative example the envelope/tube comprises protrusions.

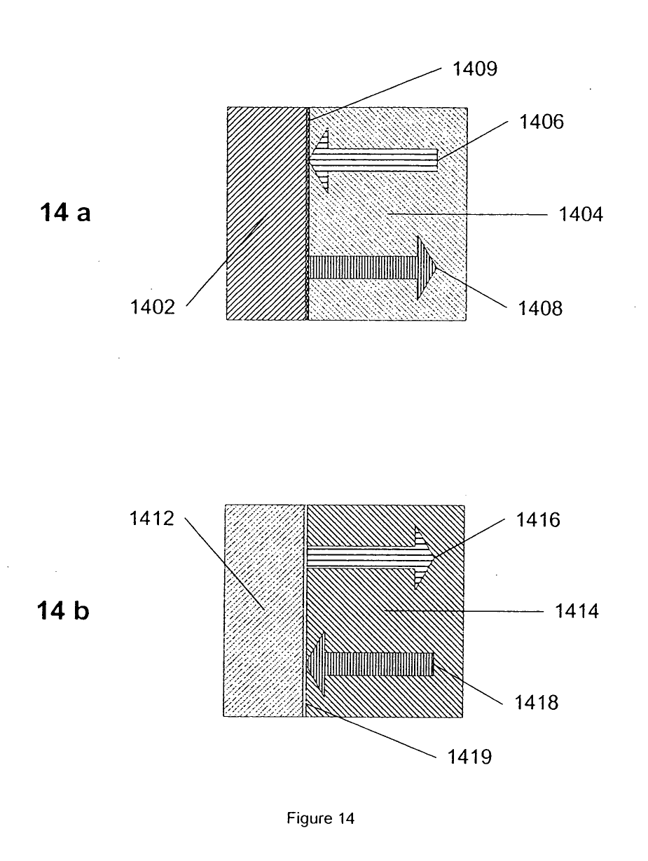

The rate of mineral attachment upon the exterior of lamp cooling jackets is highly influenced by the relative temperature differential between the jacket surface and the surrounding process water. This fact can be used advantageously related to mitigating the problem of fouling of the lamp cooling jacket. FIG. 14 illustrates the potentially useful relationships for both minerals and volatile organic compounds (VOCs) for two differential temperature conditions. Refer now to differential temperature condition FIG. 14a. When the cooling jacket is warmer than the water in contact with it, the minerals attach at a rate that is a function of the temperature gradient, and this attachment rate (fouling) increases with increasing jacket temperature. In this relationship the warmer cooling jacket 1402 presents a condition whereby the minerals 1406 within the colder process water 1404 and in contact with the warm-cold surface interface 1409 will tend to attach to said warm-cold surface interface 1409. Refer now to differential temperature condition FIG. 14b. Conversely, a cooling jacket that is colder relative to the surrounding process water will naturally resist the thermally-induced attachment of minerals. In this relationship the colder cooling jacket 1412 presents a condition whereby the minerals 1416 within the warmer process water 1414 are less likely to attach to the cold-warm surface interface 1419, thereby remaining in suspension within the warmer process water 1414. It is also useful to know that the opposite attraction-repulsion effect occurs with most volatile organic compounds (VOCs) that might be suspended within various process waters or fluids. Referring to FIG. 14b for example, in process waters where the outside surface of the cooling jacket is colder than the process water, most minerals of interest will naturally remain dissolved/suspended within the water and not attach to the cooling jacket, while most VOCs will naturally condense upon the colder cooling jacket. In this relationship the colder cooling jacket 1412 encourages VOCs 1418 within the warmer process water 1414 to condense upon the cold-warm surface interface 1419. The opposite effect is illustrated by FIG. 14a, wherein the warmer cooling jacket 1402 encourages the VOCs 1408 within the colder process Water 1404 to avoid attachment to the Warm-Cold Surface Interface 1409 and remain dissolved within Colder Process Water 1404. It is important to understand that for each compound type (mineral and VOC) the rate of the respective effects is increased with increasing temperature differential at the interface of the jacket surface and the surrounding process fluid.

By actively controlling the relationship of temperature differential between the outer surface of the cooling jacket and the surrounding process fluid, this invention advantageously provides a means whereby many lamp-based processes can be optimized for the application. For one example, an application involving UV disinfection of drinking water, the problem of mineral fouling can be mitigated by producing an intelligent, actively-controlled temperature relationship at the interface of the cooling jacket and drinking water. Temperature monitoring of both the process water and the cooling jacket fluid provides useful inputs to a simple refrigerator control system, which determines and actively produces the optimum coolant temperature and/or flow rate for mitigation of mineral fouling. Additionally, mineral sensors can also provide to the control system information that helps determine the degree of “anti-fouling” temperature correction necessary for a particular water quality condition, thereby constantly optimizing the efficiency of the fouling mitigation process.

As an alternative example, a water remediation application involving the UV photodissociation of toxic VOCs in industrial process water, the reaction efficiency can be improved by using an intelligent, actively-controlled temperature relationship at the interface of the cooling jacket and drinking water. By attracting and condensing the VOCs upon the cooling jacket surface, which is the region within the UV reactor with the highest UV fluence distribution rate, the VOCs are advantageously exposed to the greatest UV photon flux density, thereby increasing the efficiency of the photodissociation process. As in the first example, various monitors and/or detectors can be incorporated as inputs so that the control system actively produces the optimum coolant temperature and/or flow rate for photodissociation of VOCs. Additionally, VOC sensors can also provide to the control system information that helps determine the degree of “anti-VOC” temperature correction necessary for a particular water quality condition, thereby constantly optimizing the efficiency of the VOC remediation process.

The lamp cooling control system can analyze all of the relevant contributing parameters (e.g., coolant and process water temperatures, flow rates, lamp output power, and if useful, the relative concentrations and types of minerals and/or VOCs) in order to provide the most optimum cooling jacket operating conditions for any given application scenario. Active control can be provided by any of numerous known methods, such as intelligent microprocessor-based algorithms.

While this invention is most easily adapted to and advantageous for pulsed flash lamp systems, the advantages described earlier can also be effectively applied to continuous wave (CW) lamp systems. This novel approach is particularly effective if combined with a means to solve the earlier-described differential temperature problems. These differential temperature problems have been considered to be one of the inherent disadvantages of continuous wave mercury lamps. The temperature control means described below permits temperature control of the interface of the cooling jacket and process, yet simultaneously maintains the necessary (and ultimately precise) high operating temperature best suited for optimum CW lamp output efficiency.

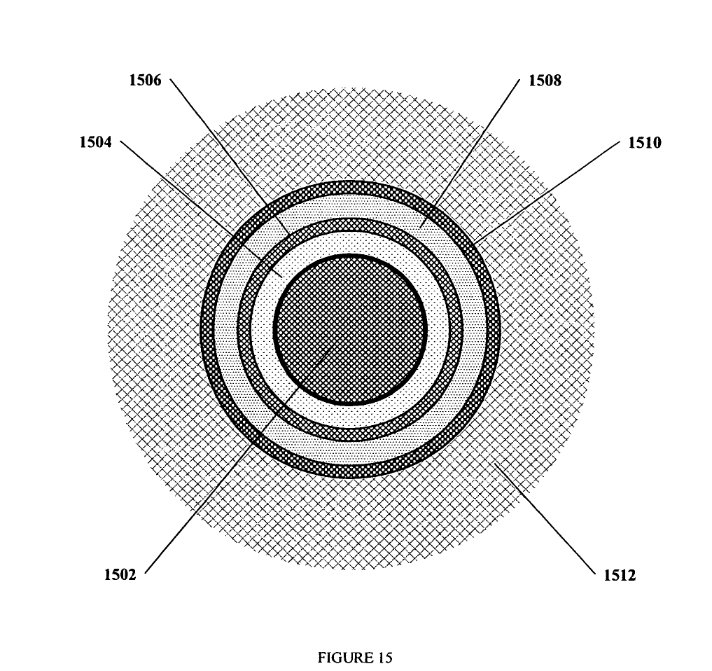

FIG. 15 shows a cross-sectional representation of such a device, comprising a CW mercury lamp 1502, surrounded by: gaseous convection cooling volume 1504, cooling jacket #1 1506, coolant fluid 1508, cooling jacket #2 1510, and process water 1512. In contrast to the practiced art of coupling (via gas convection) the lamp heat into a single cooling jacket, and then through this cooling jacket (via conduction) directly into the process water (with the corresponding detrimental elevated temperature differential), this method advantageously incorporates two cooling jackets and a closed-loop cooling system in a manner that can simultaneously: 1/allow active control of the differential temperature of the interface between the process water 1512 and cooling jacket #2 1510, and 2/allow active and real-time control of the operating temperature of the CW mercury lamp 1502. Cooling jacket #1 1506 allows conduction of most of the gas-convected lamp heat into the coolant fluid 1508 of the closed-loop cooling system, and the rate at which it removes that heat determines the operating temperature of the lamp 1502. The rate of lamp heat removal is dependent upon both the coolant temperature and flow rate, so a real-time and intelligent control of these parameters can optimize the lamp output performance. Utilizing the input from ordinary temperature sensors for the lamp, cooling water, and process water, active control of this cooling system provides throughout a broad range of operating conditions (varying lamp input power, light output, process water flow and temperature) the optimum thermal buffer for maintaining a consistent optimum lamp output. Active control can be provided by any of numerous known methods, such as intelligent microprocessor-based algorithms. By balancing the cooling system operating parameters, both advantageous conditions (#1 and #2, above) can simultaneously be achieved by this invention, thereby resulting in the unique capability to directly and accurately control the lamp output power, and to substantially reduce the operation and maintenance problems due to thermal-induced mineral fouling of the lamp cooling jacket.

Having now described a few embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention and any equivalent thereto. It can be appreciated that variations to the present invention would be readily apparent to those skilled in the art, and the present invention is intended to include those alternatives. Further, since numerous modifications will readily occur to those skilled in the art, it is not desired to limit the invention to the exact construction and operation illustrated and described, and accordingly, all suitable modifications and equivalents may be resorted to, falling within the scope of the invention.

Preliminary Claims:

1. Pulsed broadband and/or ultraviolet (PUV) lamp comprising:
a. The lamp tube made of suitable radiation transparent material,
b. The working gas inside the tube,
c. Electrodes supplying current to the gas inside the tube,
d. A suitable radiation transparent cooling jacket that houses the lamp tube made of a suitable radiation transparent material,
e. Means for cooling the lamp including
   i. A cooling agent between lamp tube and cooling jacket,
   ii. Means for moving and cooling the cooling agent

2. Pulsed broadband and/or ultraviolet (PUV) lamp according to claim 1 wherein the cooling agent is pressurized in the range of 15 psi to 150 psi

3. Pulsed broadband and/or ultraviolet (PUV) lamp according to claim 1 wherein cooling agent has one or more hydrophobic additives

4. Pulsed broadband and/or ultraviolet (PUV) lamp according to claim 1 and 3 wherein the cooling agent is a liquid selected from the groups of high stability fluids: hydrocarbons, Freon, sulfur hexafluoride, organosilicons

5. Pulsed broadband and/or ultraviolet (PUV) lamp according to claim 1 and 2 wherein the cooling agent is liquid free from atmospheric gases, including oxygen, nitrogen and carbonic gases

6. Pulsed broadband and/or ultraviolet (PUV) lamp according to claim 1 wherein the cooling agent is liquid that is free from atmospheric gases, including oxygen, nitrogen and carbonic gases

7. Pulsed broadband and/or ultraviolet (PUV) lamp according to claim 1 and 5 wherein the cooling agent is evacuated by means of a sub-atmospheric pressure, preferably at a pressure of less than 70000 pascal.

8. Pulsed broadband and/or ultraviolet (PUV) lamp according to claim 5 wherein the cooling agent is degassed before, during, or after installation into the cooling system.

9. Pulsed broadband and/or ultraviolet (PUV) lamp according to claim 5 wherein the cooling agent is degassed during utilization of the lamp.

10. Pulsed broadband and/or ultraviolet (PUV) lamp according to claim 1 wherein the cooling agent is a gas that is passive to UV radiation

11. Pulsed broadband and/or ultraviolet (PUV) lamp according to claim 10 wherein the cooling agent is argon, hydrogen, helium, or Freon™ like compounds.

12. Pulsed broadband and/or ultraviolet (PUV) lamp according to claim 10 wherein the cooling jacket consists of large panels or tubes made of FEP or Teflon™ AF or similar material, and the forced cooling gas is pressurized in order to structurally support the cooling jacket against the pressure of the surrounding process water. This requires pressure sensor(s) for each side, and active control of the pressure of the forced gas.

13. Pulsed broadband and/or ultraviolet (PUV) lamp according to claim 1 wherein metal component surfaces in contact with the cooling agent are coated by non-metal materials

14. Pulsed broadband and/or ultraviolet (PUV) lamp according to claim 1 wherein the wetted components for cooling the lamp are manufactured from non-metal materials

15. Pulsed broadband and/or ultraviolet (PUV) lamp according to claim 12 and 13 wherein the non-metal materials consist of polyethylene or Teflon™-like group materials

16. Pulsed broadband and/or ultraviolet (PUV) lamp according to claim 1 and 12 wherein surfaces in contact with the cooling agent coated by a layer of hydrophobic material

17. Pulsed broadband and/or ultraviolet (PUV) lamp according to claim 1 wherein the cooling agent is a mixture of liquid and gas

18. Pulsed broadband and/or ultraviolet (PUV) lamp according to claim 1 wherein the cooling agent is boiling at the contact surface of the lamp tube

19. Pulsed broadband and/or ultraviolet (PUV) lamp according to claim 1 wherein the lamp tube has outer ribs

20. Pulsed broadband and/or ultraviolet (PUV) lamp according to claim 1 and 19 wherein the lamp tube has outer longitudinal ribs.

21. Pulsed broadband and/or ultraviolet (PUV) lamp according to claim 1 and 19 wherein the lamp tube has outer ring-like (annular) ribs.

22. Pulsed broadband and/or ultraviolet (PUV) lamp according to claim 1 and 19 wherein the lamp tube has spiral outer rings.

23. Pulsed broadband and/or ultraviolet (PUV) lamp according to claim 1 wherein the cooling jacket has inner ribs

24. Pulsed broadband and/or ultraviolet (PUV) lamp according to claim 1 and 23 wherein the cooling jacket has inner longitudinal ribs.

25. Pulsed broadband and/or ultraviolet (PUV) lamp according to claim 1 and 23 wherein the cooling jacket has inner ring-like (annular) ribs.

26. Pulsed broadband and/or ultraviolet (PUV) lamp according to claim 1 and 23 wherein the cooling jacket has spiral inner rings.

27. Pulsed broadband and/or ultraviolet (PUV) lamp according to claim 1 wherein there is one or more ring-like (annular) dimensional support spacers between and in contact with the lamp tube and cooling jacket

28. Pulsed broadband and/or ultraviolet (PUV) lamp according to claim 1 and 27 wherein the spacers are longitudinally located for suppression of vibration modes

29. Pulsed broadband and/or ultraviolet (PUV) lamp according to claim 1 and 27 wherein the spacers are longitudinally located for increasing turbulence and efficiency of the cooling agent

30. Pulsed broadband and/or ultraviolet (PUV) lamp according to claim 1 and 27 wherein the spacers are designed so that thermal expansion resulting from lamp heating provides direct solid surface contacts between the lamp tube and cooling jacket, thereby promoting conductive heat transfer

31. Pulsed broadband and/or ultraviolet (PUV) lamp according to claim 1 wherein the cooling jacket has a cross-sectional shape that is non-round

32. Pulsed broadband and/or ultraviolet (PUV) lamp according to claim 1 and 31 wherein the cooling jacket has a cross-sectional shape that increases the mechanical strength of the assembly

33. Pulsed broadband and/or ultraviolet (PUV) lamp according to claim 1 and 31 wherein the cooling jacket has a cross-sectional shape that attenuates the harmful effect of shock waves.

34. Pulsed broadband and/or ultraviolet (PUV) lamp comprising:
a. The lamp tube made of suitable radiation transparent material,
b. The working gas inside the tube,
c. Electrodes supplying current to the gas inside the tube,
d. A suitable radiation transparent cooling jacket that houses the lamp tube made of a suitable radiation transparent material,
e. Means for cooling the lamp including
   i. A cooling agent between lamp tube and cooling jacket,
   ii. Means for moving and cooling the cooling agent
f. Means for determining in real-time the optimum lamp cooling system operating parameters, including
   i. Sensors for determining the temperatures of the lamp, cooling agent, cooling jacket and process fluid surrounding the exterior wall of the cooling jacket
   ii. Real-time microprocessor control system (or equivalent), including
      1. Appropriate algorithms
      2. Inputs from Temperature Sensors
g. Means for achieving the in real-time the optimum lamp cooling system operating parameters, including
   i. Means for controlling the temperatures of the lamp, cooling agent, cooling jacket, and the differential temperature between the cooling jacket and process fluid surrounding the exterior wall of the cooling jacket, including
      1. Real-time microprocessor control system (or equivalent), including
         a. Appropriate algorithms
         b. Outputs for controlling
         i. temperature of the cooling agent
         ii. flow rate of the cooling agent

35. Continuous wave mercury lamp(s) comprising:
a. The lamp tube made of suitable radiation transparent material,
b. The working gas inside the tube,
c. Electrodes supplying current to the gas-inside the tube,
d. A suitable radiation transparent cooling jacket #1 that houses the lamp tube made of a suitable radiation transparent material,
e. A suitable radiation transparent cooling jacket #2 that houses the cooling jacket #1,
f. Process fluid in contact with and surrounding the exterior wall of cooling jacket #2,
g. Means for cooling the lamp including
   i. A convection cooling gas between the lamp tube and cooling jacket #1,
   ii. A cooling agent between cooling jacket #1 and cooling jacket #2
   iii. Means for moving and cooling the cooling agent
h. Means for determining in real-time the optimum lamp cooling system operating parameters, including
   i. Sensors for determining the temperatures of the lamp, cooling jacket #1, cooling agent, cooling jacket #2, and process fluid surrounding the exterior wall of cooling jacket #2
   ii Real-time microprocessor control system (or equivalent), including
      1. Appropriate algorithms
      2 Inputs from temperature sensors
i. Means for achieving the in real-time the optimum lamp cooling system operating parameters, including
   i. Means for controlling the temperatures of the lamp, cooling agent, cooling jackets #1 and #2, and the differential temperature between cooling jacket #2 and process fluid surrounding the exterior wall of cooling jacket #2, including
      1. Real-time microprocessor control system (or equivalent), including
         a. Appropriate algorithms
         b. Outputs for controlling
         i. temperature of the cooling agent
         ii. flow rate of the cooling agent

What is claimed is:

1. A lamp comprising:
a lamp tube, said lamp tube comprising a radiation transparent material, an inner lamp tube surface, and an outer lamp tube surface;
a gas, said gas residing within said lamp tube; and
at least one electrode, said at least one electrode residing at least partially within said lamp tube;
a jacket, wherein said jacket houses said lamp tube, said jacket comprising a radiation transparent material, an inner jacket surface and an outer jacket surface;
a space, said space residing between said inner jacket surface and said outer lamp tube surface; and
a cooling means, wherein a cooling agent can be added to said cooling means, once added said cooling agent residing within said space, said cooling means further comprising a means for cooling and/or moving said cooling agent.

2. The lamp according to claim 1, wherein said lamp is used to produce high power pulsed broadband light.

3. The lamp according to claim 1, wherein the cooling agent is pressurized to at least 15 psi and wherein the cooling agent is pressurized to no more than 150 psi.

4. The lamp according to claim 1, wherein the cooling agent has one or more hydrophobic additives.

5. The lamp according to claim 1, wherein the cooling agent is a liquid selected from the group of high stability fluids consisting of hydrocarbons, Freon, sulfur hexafluoride, and organosilicons.

6. The lamp according to claim 2, wherein the cooling agent is a liquid and wherein the cooling agent is substantially free from oxygen, nitrogen and carbonic gases.

7. The lamp according to claim 6, wherein the cooling agent is degassed before, during, or after said cooling agent is added into the cooling means or wherein the cooling agent is degassed during lamp use.

8. The lamp according to claim 1, wherein the cooling agent is evacuated by means of a sub-atmospheric pressure, and wherein said sub-atmospheric pressure is less than 70000 pascal.

9. The lamp according to claim 1, wherein the cooling agent is a gas, and wherein the gas is passive to UV radiation.

10. The lamp according to claim 9, wherein the cooling agent is argon, hydrogen, helium, or Freon.

11. The lamp according to claim 9, the jacket comprising panels or tubes, said panels or tubes comprising fluorinated ethylene-propylene (FEP) or polytetrafluoroethylene (PTFE) or Teflon AF, wherein the cooling agent is pressurized, and wherein said pressurized cooling agent provides structural support to the jacket.

12. The lamp according to claim 11, further comprising:
at least one pressure sensor, wherein said at least one pressure sensor senses pressure of the jacket; and
an active controlling means, wherein said active controlling means controls the pressure of the gas.

13. The lamp according to claim 1, further comprising lamp assembly components or cooling means components, at least a portion of said lamp assembly components or cooling means components comprising metal, wherein at least a portion of said lamp assembly components or cooling means components comprising metal are in contact with the cooling agent, and wherein said lamp assembly components or cooling means components comprising metal in contact with the cooling agent are coated with a non-metal material.

14. The lamp according to claim 1, further comprising lamp assembly components or cooling means components wherein at least a portion of said lamp assembly components or cooling means components are in contact with the cooling agent, and wherein said lamp assembly components or cooling means components in contact with the cooling agent comprise a non-metal material.

15. The lamp according to claim 13, wherein the non-metal material comprises one of: polyethylene, polytetra fluoroethylene (PTFE), fluorinated ethylene-propylene (FEP), perfluoroalkoxy polymer resin (PFA), and Teflon AF.

16. The lamp according to claim 14, wherein the non-metal material comprises one of: polyethylene, polytetra fluoroethylene (PTFE), fluorinated ethylene-propylene (FEP), perfluoroalkoxy polymer resin (PFA), and Teflon AF.

17. The lamp according to claim 1, wherein at least a portion of said outer lamp tube surface is in contact with the cooling agent, and wherein said at least a portion of said outer lamp tube surface that are in contact with the cooling agent are coated with a layer of hydrophobic material.

18. The lamp according to claim 1, wherein the cooling agent is a mixture of liquid and gas.

19. The lamp according to claim 1, said lamp tube further comprising a contact surface, wherein the cooling agent is boiling at said contact surface.

20. The lamp according to claim 1, said lamp tube comprising ribs.

21. The lamp according to claim 20, wherein said ribs are outer, outer longitudinal, outer annular, inner, inner longitudinal, or inner annular.

22. The lamp according to claim 1, said lamp tube comprising spiral outer rings or spiral inner rings.

23. The lamp according to claim 1, further comprising at least one support spacer, said at least one support spacer being located between and in contact with the lamp tube and the jacket.

24. The lamp according to claim 23, wherein each of said at least one spacer is at least one of annular and longitudinally located.

25. The lamp according to claim 1, further comprising at least one support spacer, said at least one support spacer being designed and incorporated into said lamp so that thermal expansion of said at least one spacer provides direct solid surface contacts between the lamp tube and the jacket.

26. The lamp according to claim 1, wherein the cooling jacket has a cross-sectional shape that is non-round.

27. The lamp according to claim 1, further comprising at least one check valve, wherein said at least one check valve directs the flow of said cooling agent.

28. The lamp according to claim 1, wherein said cooling means is vertically oriented, said cooling means further comprising an evaporator and a condenser.

29. A lamp comprising:
a lamp tube, said lamp tube comprising a radiation transparent material, an inner lamp tube surface, and an outer lamp tube surface;
a gas, said gas residing within said lamp tube; and
at least one electrode, said at least one electrode residing at least partially within said lamp tube;
a jacket, wherein said jacket houses said lamp tube, said jacket comprising a radiation transparent material, an inner jacket surface and an outer jacket surface;
process fluid, wherein said process fluid surrounds said outer jacket surface;
a space, said space residing between said inner jacket surface and said outer lamp tube surface;
a cooling means, said cooling means comprising a cooling agent, said cooling agent residing within said space, and a means for cooling and/or moving said cooling agent;
at least one sensor for sensing at least one of lamp temperature, cooling agent temperature, jacket temperature, or process fluid temperature;
a microprocessor control system comprising algorithms and sensor input; and
a controlling means for controlling at least one of the temperatures of the lamp, cooling agent, jacket, or differential temperature between the jacket and process fluid, said controlling means comprising a second microprocessor control system comprising at least one algorithm and outputs for controlling at least one of temperature of the cooling agent or flow rate of the cooling agent.

30. A lamp comprising:
a lamp tube, said lamp tube comprising a radiation transparent material, an inner lamp tube surface, and an outer lamp tube surface;
a gas, said gas residing within said lamp tube; and
at least one electrode, said at least one electrode residing at least partially within said lamp tube;
a first jacket, wherein said first jacket houses said lamp tube, said first jacket comprising a radiation transparent material, an inner first jacket surface and an outer first jacket surface;
a second jacket, wherein said second jacket houses said first jacket, said second jacket comprising a radiation transparent material, an inner second jacket surface and an outer second jacket surface;
process fluid, wherein said process fluid surrounds said outer second jacket surface;
a first space, said first space residing between said first inner jacket surface and said outer lamp tube surface;
a second space, said second space residing between said first outer jacket surface and said inner second jacket surface;
a first cooling means, said first cooling means comprising a first cooling agent, said first cooling agent residing within said first space;
a second cooling means, said second cooling means comprising a second cooling agent, said second cooling agent residing within said second space;
at least one sensor for sensing at least one of lamp temperature, first cooling agent temperature, second cooling agent temperature, first jacket temperature, second jacket temperature, or process fluid temperature;
a microprocessor control system comprising algorithms and sensor input; and
a controlling means for controlling at least one of the temperatures of the lamp, first cooling agent, second cooling agent, first jacket, second jacket, or differential temperature between the jacket and process fluid, said controlling means comprising a second microprocessor control system comprising at least one algorithm and outputs for controlling at least one of temperature of the cooling agent or flow rate of the cooling agent.

31. The lamp according to claim 29, wherein the lamp is at least one of a pulsed broadband or ultraviolet lamp.

32. The lamp according to claim 30, wherein the lamp is a continuous wave mercury lamp.
